(19) United States
(12) Patent Application Publication
(10) Pub. No.: US 2011/0132791 A1
(43) Pub. Date: Jun. 9, 2011

(54) PACKAGING UNIT

(75) Inventors: Wijbe Dijkstra, Friesland (NL); Hendrik Freerk Kloosterman, Friesland (NL); Christian Niemarkt, Friesland (NL)

(73) Assignee: HUHTAMAKI NEDERLAND B.V., Franeker (NL)

(21) Appl. No.: 12/996,320

(22) PCT Filed: Jun. 3, 2009
(86) PCT No.: PCT/NL2009/050306

§ 371 Date: Jan. 18, 2011

(30) Foreign Application Priority Data
Jun. 3, 2008 (EP) 08157501.1

(51) Int. Cl. B65D 81/02; B29C 43/36

(52) U.S. Cl. 206/521.8; 264/299

(57) ABSTRACT

The invention pertains to a set of mutually connected packaging units (1,1′) for eggs or similar fragile articles, made of moulded pulp and comprising a bottom part (2) comprising compartments (4) matching at least partially the outer contours of the articles contained within said unit, a cover part (3) comprising a top surface (7) and substantially planar front- and rear surfaces (8) and substantially planar end surfaces (9), said cover part substantially having a rectangular shape with rounded corners, said packaging connected at their ends of their bottom parts and their cover parts via bridging parts (15,16), wherein said bridging parts are compressed.

### BACKGROUND

The present invention relates to a packaging unit for eggs and similar articles. Egg cases or cartons are a well known example of such a packaging unit. An example of such an egg case is disclosed in U.S. Pat. No. 3,813,027 and EP-1,373,100. Usually, these egg cartons are made of moulded paper material or synthetic material, and comprise a number of pockets for accommodating eggs of similarly shaped, fragile articles like for instance kiwi fruits. These packaging units usually have a bottom part or tray section which has a number of pockets or compartments for holding the articles.

The packaging units further have a cover section or cover part which may be hingedly connected to the bottom part.

U.S. Pat. No. 3,50,083 discloses an egg carton with a bottom part and a cover part hingedly connected to it. The egg carton has denesting provisions formed from indentations. In order to function properly, the egg carton needs to come in two versions which need to be stacked alternately. Thus, stacking of two stacks may already lead to problems. Production speed of packaging apparatus increases, with speeds up to 120,000 eggs per hour. Less human interference is desired and the packages need to be stacked in higher stacks. Therefore, machine handling of the packaging units needs to be improved.

WO-2005085095 discloses packaging units, in particular egg cartons, which are produced with traditional connection parts or bridging parts. After cutting the bridging parts in order to separated the packaging units, the cutting ends fray. Documents U.S. Pat. No. 3.767.103 and U.S. Pat. No. 3.145.896 disclose similar bridging parts.

The package units are provided to a packaging machine in a nested way, and need to be denested by the packaging machine. This needs to be done in a reliable way. Machine handling of these packaging units can therefore be improved.

Furthermore, regarding the strength, the stackability and denesting of the packaging units there is room for improvement.

### SUMMARY OF THE INVENTION

The invention aims at providing an alternative packaging unit.

Another object of the invention is to improve the packaging unit.

Yet another object of the invention is to provide a packaging unit that can be handled by a machine in a more reliable way or faster.

Yet another or alternative object of the invention is to provide a packaging unit with an improved appearance.

The invention provides a set of mutually connected packaging units for eggs or similar fragile articles, made of moulded pulp and comprising a bottom part comprising compartments matching at least partially the outer contours of the articles contained within said unit, a cover part comprising a top surface and substantially planar front- and rear surfaces and substantially planar end surfaces, said cover part substantially having a rectangular shape with rounded corners, said packaging connected at their ends of at least one selected from their bottom parts and their cover parts via a bridging part or bridging parts, wherein said bridging part or bridging parts comprise a compressed region.

Tests showed that by compressing said bridging parts, the ends would not fray after cutting the bridging part or parts for separating the packaging units. Often, the packaging units have bridging parts connecting both bottom parts and cover parts.

In an embodiment, said compressed region is compressed with respect to regions neighbouring said compressed region. In some applications, large part of the bridging part or parts is compressed.

In an embodiment, said compressed region is compressed to have a higher density than the further packaging units. It thus often has a smaller wall thickness than the further packaging units.

In an embodiment, said bridging parts comprise a compressed band, in an embodiment 3-10 mm wide, in an embodiment extending over said bridging part or parts, from one end to the other.

In an embodiment, the wall thickness of said bridging parts after compression is about 30-70% of the original wall thickness. In practise, this often results in an increase in density of about 30-70%.

In an embodiment, one side or surface of said bridging parts is compressed, in an embodiment the side of said bridging parts which are faced to one another when said packaging unit is closed. This results in an impressed or imprinted region. This, the feature does not influence the appearance and still reduces fraying of the cut edges.

In an embodiment, The invention further pertains to a method for making a set of packaging units of any one of the preceding claims, wherein a set of packaging units is moulded from a pulp to form a pre-shape, and said moulded pre-shape is compressed in a compression mould, wherein said compression mould has a mould wall which comprises an elevated region at the location of said bridging parts.

In an embodiment, said elevated region extends in one half of said mould. As a result of the elevated region, a region results in which the density is larger than the further packaging. Thus, if compression is 30-70% of the original wall thickness, the density will increase with about the same percentage.

In an embodiment, said elevated region extends about 0.3-0.6 mm above the adjacent mould wall.

The invention further pertains to a mould for a set of packaging units according to any one of the preceding claims, wherein said mould has a mould wall which comprises an elevated region at the location of said bridging parts.

The invention further pertains to a packaging unit for eggs or similar fragile articles, made of moulded pulp and comprising a bottom part comprising compartments matching at least partially the outer contours of the articles contained within said unit, a cover part comprising a top surface and substantially planar front- and rear surfaces and substantially planar end surfaces, said cover part substantially having a rectangular shape with rounded corners, wherein said packaging has a wall thickness, and at least one end of said bottom part and said cover part comprises a compressed end which has a thickness of about 30-70% of the original wall thickness, in particular about 40-60% of the original wall thickness.

The invention further relates to a packaging unit for eggs or similar fragile articles, made of moulded pulp and comprising:
a bottom part comprising compartments matching at least partially the outer contours of the articles contained within said unit;
a cover part comprising a top wall with an inner and outer surface, and substantially planar front- and rear walls with inner and outer surfaces and substantially planar end wall with an inner and outer surface, said cover part substantially having a rectangular shape with rounded corners;
wherein said cover part comprises denesting means provided by at least one thickened part of at least one of said walls on at least one of inner surfaces of said cover part.

Several denesting means have been proposed. Some of the known denesting means require two different types of packagings which have to be stacked alternately, as for instance disclosed in U.S. Pat. No. 3,501,083. In an embodiment, the denesting means comprises at least one thickened part of the top wall, said thickening provided on its inner surface. This, a further design freedom is developed. In an embodiment, the thickened part or parts are positioned to abut the outer surface of the cover part for providing a space between two nested packagings. In an embodiment, at least two thickened wall parts are provided at remote positions on an inner surface of the cover part. In an embodiment, the thickened part or parts work together with an abutment on the outer surface of the cover part. These form the denesting means or de-stacking means. The abutment on the outer surface provide an abutment in a direction substantially normal to the outer surface or the top wall for providing a defined distance between two stacked packagings. The denesting means may thus be provided below the top wall. It may be provided above a lower rim of the cover part.

The invention further relates to a packaging unit comprising one or more of the characterising features described in the description and/or shown in the attached drawings, and to a method comprising one or more of the characterising features described in the description and/or shown in the attached drawings.

The various aspects discussed in this patent can be combined in order to provide additional advantages. Furthermore, several of the aspects discussed and disclosed in this descriptions or shown in the drawings, such as the denesting provisions, can be the topic of one or more divisional applications.

### DESCRIPTION OF THE DRAWINGS

The invention will be further elucidated referring to an embodiment of a packaging unit shown in the drawings wherein shown in:

FIG. 1 a perspective view of two packaging units interconnected at one of their end surfaces;

FIG. 2 a top view of FIG. 1;

FIG. 3 a cross section of FIG. 2 as indicated

FIG. 4 a detail of FIG. 3 in cross section as indicated;

FIG. 5 a detail of an alternative denesting feature.

### DETAILED DESCRIPTION OF EMBODIMENTS

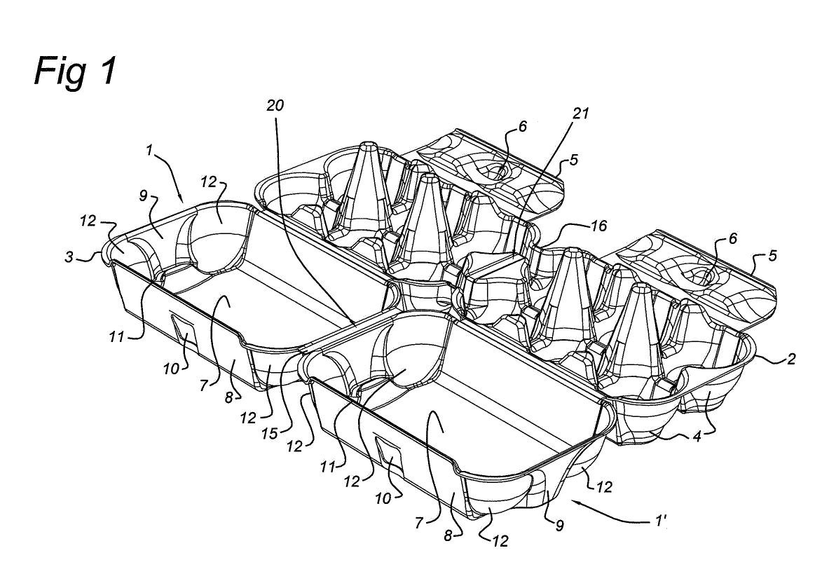

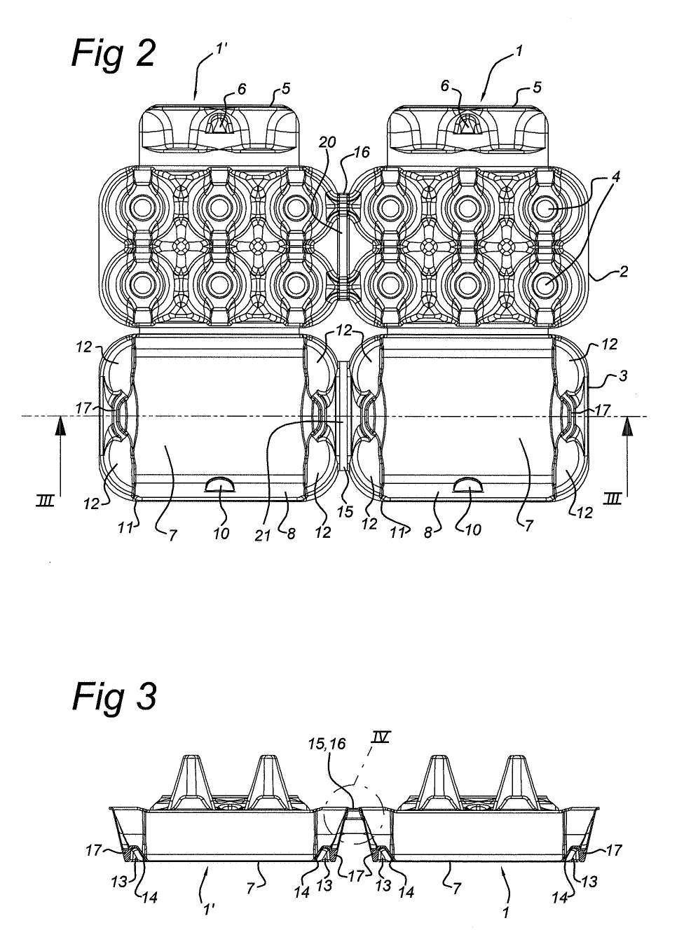

In FIG. 1, a perspective view is shown of two packaging units 1, 1′ which are interconnected at their end surface sides. The two packaging units are here connected via bridging parts 15 and 16 at their ends. Both packaging units 1, 1′ can accommodate 6 eggs. Before or more preferred, after eggs or other articles have been placed in the compartments, and possibly after the packaging units have been closed, the bridging parts 15, 16 between both packaging units 1, 1′ can be deleted, for instance by cutting. According to this aspect of the invention in this embodiment, a band 20, 21 over these bridging parts 15, 16 has been compressed. The compression has been done by applying pressure using a press.

Usually, when making a moulded packaging, the shape is first moulded using a rough moulding. The rough mouldings are dried. After that, the dried rough moulds are after-pressed in a mould. In an embodiment, in the mould at the location of the bridging parts 15, 16, an additional rim or elevated part is provided which provides the compressed bands 20, 21. A next step in production or after filling the packaging with products a cutting the bridging parts 15, 16 in order to provide separate packagings. This cutting is for instance done using a circular, rotating blade or using a cutting knife. This cutting usually results in a frayed edge. When first compressing the bridging parts, it was found that the fraying was largely reduced, if not fully absent. This provides a professional and clean edge after the packagings 1, 1′ are separated by cutting.

One packaging units 1 will be described in detail. Packaging unit 1 has a bottom part 2 and a cover part 3. Cover part 3 is here (not visible) hingedly connected to the bottom part 2. The bottom part 2 has compartments 4 for accommodating the fragile articles, in order to maintain them in an upright position and preventing them from touching one another. These compartments 4 are well known in the art.

In order to lock the cover part 3 on bottom part 2, in this embodiment the bottom part 2 has a locking flap 5 hingedly connected to it, along its longitudinal or front side. This locking flap 5 is provided with a cam 6 which matching an opening 10 in the front surface 8 of the cover part 3. The locking provision of locking flap 5 with the cam 6 and the opening 10 in the cover part 3 as such is well known in the art. Cam 6 substantially fits closely in opening 10.

The cover part 3 of this embodiment further has a planar top surface 7, a planar front surface 8 and a planar rear surface (not visible here). These surfaces together provide here a rectangular area onto which a label can be provided. A rectangular label is advantageous from a handling point of view. Furthermore, proper application of a substantially rectangular label is easier and more reliable.

The cover part 3 in this embodiment further has substantially planar end surfaces 9. These end surfaces 9 and front surface 8 and the rear surface (not visible here) are connected via portions 12 reflecting the shape of the articles contained within said packaging unit. In fact, the lower rim or peripheral flange 11 shows the lower side of the cover part 3 which shows a shape having end surfaces which connect to the front and rear surfaces via rounded corners. From these virtual, rounded, cylindrical corners, parts have been taken out, or, so to say, the wall has been reformed towards the inside of the cover part 3, so as to result in the portions 12. At their lower ends, these portions almost follow the original rounded, cylindrical corners. Higher up, larger parts have been taken out. Thus, the width of the end portions 9 becomes smaller closer to the top surface 7. The portions 12 are defined as having a positive curvature.

In the sideward protruding parts of the top surface 7 which continue into the end surfaces 9, indentations 13 have been provided. These indentations 13 have the visual effect of emphasizing the rectangular area provided by the top surface 7, the front surface 8, and the (hidden) rear surface. Furthermore, it increases the strength of the cover part 3 and provides a denesting means without interfering with the labelling area.

Here, the indentations 13 have sloping walls 14. These walls 14 are inclined towards the end surfaces 9, respectively.

In FIG. 3, which shows the cover parts in cross section, the construction of the denesting means 13 of this embodiment can be seem in detail. The space 17 between the indentations 13 and the end surfaces 9 are completely filled.

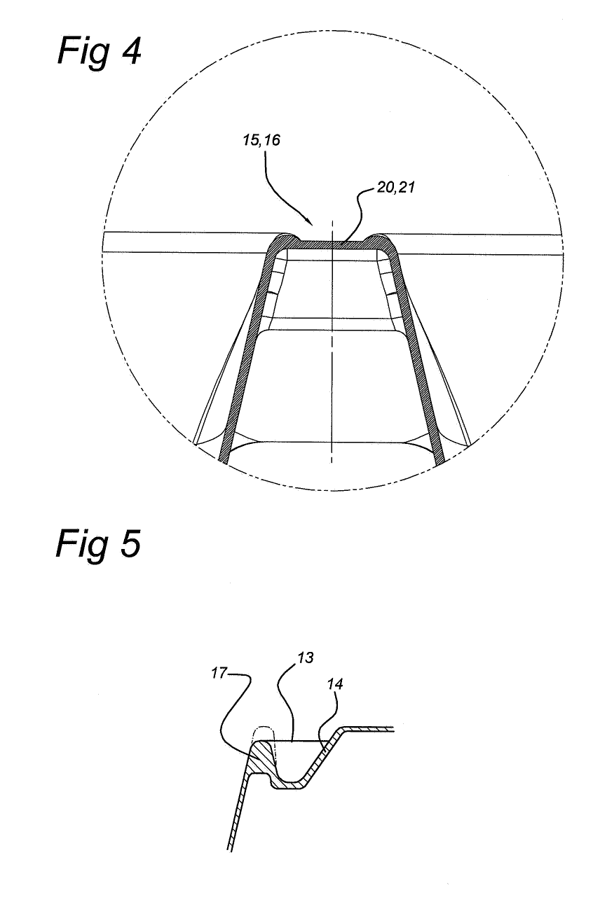

FIG. 4 shows in detail the compressed regions 20, 21 of the bridging parts 15, 16. In this embodiment, one side of the bridging parts 20, 21 was compressed. In this embodiment, they are the sided which face one another when said lid 3 is closed. Thus, the outside does not show the compressed region. Usually, the wall thickness D1 of the bridging parts 15, 16 is about 1.1 mm. In this embodiment, a region of the bridging parts 15, 16 is compressed to a wall thickness D2 of about 0.6 mm. This amount of compression in this embodiment showed to be sufficient for avoiding frayed edges. In fact, an amount of compression of about 30-70%, in particular 40-60%, was sufficient.

The width of the compressed band in this embodiment was 4.8 mm. A width of about 3-10 mm proved to be sufficient. A width of about 4-6 mm provided a narrow band which could still be cut without errors and failures.

FIG. 5 illustrates an alternative to the denesting feature 13 of FIG. 3. In this embodiment, again a wall part 17 is thickened, in this embodiment the outer surface of the thickened part 17 is below the plane of the upper surface 7. This is an embodiment showing the increased design freedom which the thickened wall provides. Using moulded fibre material, it is very easy to make these thickened, massive parts. The inner surface of the thickened part 17 thus works together with the outer surface of a thickened part 17 of another packaging to provide a spacing of nested or stacked packagings.

The end surface 9 in this embodiment of FIG. 5 thus does not extend to be in one plane with the top surface, but remains below this plane. The dotted line indicates the end surface 9 of FIG. 3.

The packaging unit can also have any number of compartments and any number of rows of compartments and any number of compartments per row. When the packaging unit has for instance three rows, the end surface 9 may in an embodiment extend between portions provided at each corner, i.e. four portions per packaging unit. In another embodiment, there may be a portion reflecting the shape of an article for each row. The middle row thus would have a portion reflecting the shape of for instance an egg, and this portion would more or less smoothly at both sides continue into two end surfaces.

It will also be obvious that the above description and drawings are included to illustrate some embodiments of the invention, and not to limit the scope of protection. Starting from this disclosure, many more embodiments will be evident to a skilled person which are within the scope of protection and the essence of this invention and which are obvious combinations of prior art techniques and the disclosure of this patent.

1. A set of mutually connected packaging units for eggs or similar fragile articles, made of moulded pulp and comprising:
a bottom part comprising compartments matching at least partially the outer contours of the articles contained within said unit;
a cover part comprising a top surface and substantially planar front- and rear surfaces and substantially planar end surfaces, said cover part substantially having a rectangular shape with rounded corners,
said packaging connected at their ends of at least one selected from their bottom parts and their cover parts via a bridging part or bridging parts, wherein said bridging part or bridging parts comprise a compressed region.

2. The set of packaging units according to claim 1, wherein said compressed region which is compressed with respect to regions neighbouring said compressed region.

3. The set of packaging units of claim 1 or 2, wherein said compressed region is compressed to a higher density than the further packaging units.

4. The set of packaging units according to any one of the preceding claims, wherein said compressed region comprise a compressed band, in an embodiment 3-10 mm wide, in an embodiment extending over said bridging part or parts, from one end to the other.

5. The set of packaging units according to any one of the preceding claims, wherein the wall thickness of said compressed region of said bridging parts after compression is about 30-70% of the wall thickness of neighbouring regions.

6. The set of packaging units according to any one of the preceding claims, wherein one side of said bridging parts is compressed, in an embodiment the side of said bridging parts which are faced to one another when said packaging unit is closed.

7. A method for making a set of packaging units of any one of the preceding claims, wherein a set of packaging units is moulded from a pulp to form a pre-shape, and said moulded pre-shape is compressed in a compression mould, wherein said compression mould has a mould wall which comprises an elevated region at the location of said bridging parts.

8. The method of claim 7, wherein said elevated region extends in one half of said mould.

9. The method of claim 7 or 8, wherein said elevated region extends about 0.3-0.6 mm above the adjacent mould wall.

10. A mould for a set of packaging units according to any one of the preceding claims, wherein said mould has a mould wall which comprises an elevated region at the location of said bridging parts.

11. A packaging unit for eggs or similar fragile articles, made of moulded pulp and comprising:
a bottom part comprising compartments matching at least partially the outer contours of the articles contained within said unit;
a cover part comprising a top surface and substantially planar front- and rear surfaces and substantially planar end surfaces, said cover part substantially having a rectangular shape with rounded corners,
wherein said packaging has a wall thickness, and at least one end of said bottom part and said cover part comprises a compressed end which has a thickness of about 30-70% of the original wall thickness, in particular about 40-60% of the original wall thickness, resulting in a higher material density at said compressed end.
